(19) United States
(12) Patent Application Publication
(10) Pub. No.: US 2016/0094842 A1
(43) Pub. Date: Mar. 31, 2016

(54) DETECTION SYSTEM AND DETECTION METHOD OF MULTIMEDIA INTERFACE

(71) Applicant: PEGATRON CORPORATION, Taipei City (TW)

(72) Inventors: Cheng-Chang HO, Taipei City (TW); Shu-Ming HSU, Taipei City (TW)

(21) Appl. No.: 14/855,188

(22) Filed: Sep. 15, 2015

(30) Foreign Application Priority Data
Sep. 30, 2014 (TW) 103134062

(51) Int. Cl. H04N 17/00; H04N 7/015

(52) U.S. Cl. CPC H04N 17/004; H04N 7/015

(57) ABSTRACT

The present invention discloses a detection system of multimedia interface and a detection method thereof The detection method of multimedia interface is applied to detect a first electronic device and comprises the following steps of: outputting a verification signal comprising a verification pattern by the first electronic device; receiving the verification signal and converting the verification signal into a verification pattern signal by a signal converting device; receiving the verification pattern signal by a second electronic device and transmitting the verification pattern signal in a multimedia interface format from a multimedia interface output terminal of the second electronic device to the multimedia interface input terminal of the first electronic device; and displaying the verification pattern by a display screen of the first electronic device.

### CROSS-REFERENCE TO RELATED APPLICATIONS

This Non-provisional application claims priority under 35 U.S.C. §119(a) on Taiwan Patent Application No(s). 103134062 filed on Sep. 30, 2014, the entire contents of which are hereby incorporated by reference.

### BACKGROUND

1. Technology Field

This disclosure relates to a detection system and a detection method, and more particularly, to a detection system and a detection method of multimedia interface.

2. Description of the Related Art

Multimedia interfaces, in particular a high definition multimedia interface (HDMI), are the latest generation of video/audio transmission interfaces. Comparing to a digital video interface (DVI), HDMI has broader bandwidth and safer authorization mechanism such as HDCP. Therefore, a playing equipment can send out an image and video/audio with better quality through such the interface to allow a display provided with the multimedia interface to truly display the image with clear quality. In addition, for consumers, the multimedia interface can not only provide the clear image quality but also can simplify the installation of a video/audio system by using the same cable. Therefore, the multimedia interface, in particular HDMI, has been the latest generation of video/audio transmission interface.

However, in prior, a detecting person will utilize a connecting line of the multimedia interface to connect a multimedia interface output terminal of a DVD player with a multimedia interface input terminal of an under-testing device, respectively, and output an image to the under-testing device through the DVD player to allow a display screen of the under-testing device to display the image for testing whether the multimedia interface of a video/audio device is normal or not. When the detecting person is able to see the correct image, a key “YES” is then pressed to represent that it is a good product. When the detecting person cannot see the correct image, a key “NO” is pressed to represent that it is a defective product. Sometimes, the detecting person will press the key “YES” due to his laziness so that the detecting person does not need to move the defective under-testing device out, or incautiously press the key “YES” for the defective under-testing device so that the defective under-testing device will be regarded as the good product thus to be shipped to the customer.

### SUMMARY

An aspect of the present invention is to provide a detection system of multimedia interface and a detection method thereof for improving quality control problems resulted from the laziness or incautiousness of the detection operator.

To achieve the abovementioned purpose, a detection system of multimedia interface according to the present invention is provided for detecting a first electronic device, in which the first electronic device has a display screen and a multimedia interface input terminal The detection system comprises a signal converting device and a second electronic device. The first electronic device under test outputs a verification signal comprising a verification pattern, and the signal converting device receives the verification signal and converts the verification signal into a verification pattern signal. The second electronic device has a multimedia interface output terminal and is able to be connected with the multimedia interface input terminal of the first electronic device through the multimedia interface output terminal The signal converting device is signal connected with the first electronic device and the second electronic device, respectively. The second electronic device receives the verification pattern signal from the signal converting device and transmits the verification pattern signal in a multimedia interface format to the multimedia interface input terminal of the first electronic device through the multimedia interface output terminal of the second electronic device so as to display the verification pattern by the display screen.

To achieve the abovementioned purpose, a detection method of multimedia interface according to the present invention is provided for detecting a first electronic device. The detection method comprises steps of outputting a verification signal comprising a verification pattern by the first electronic device; receiving the verification signal and converting the verification signal into a verification pattern signal by a signal converting device; receiving the verification pattern signal by a second electronic device and transmitting the verification pattern signal in a multimedia interface format from a multimedia interface output terminal of the second electronic device to the multimedia interface input terminal of the first electronic device; and displaying the verification pattern by a display screen of the first electronic device.

In an embodiment, the verification pattern comprises Arabic numerals, letters, phonetic symbols, colors or combination thereof

In an embodiment, the verification comprises a combination of a plurality of Arabic numerals and the Arabic numerals are different from each other.

In an embodiment, the signal converting device has a first signal converting unit and a second signal converting unit electrically connected with the first signal converting unit in which the first signal converting unit is electrically connected with the first electronic device and the second signal converting unit is electrically connected with the second electronic device.

In an embodiment, the first signal converting unit converts the verification signal into a digital signal and the second signal converting unit coverts the digital signal into the verification pattern signal.

In an embodiment, the first signal converting unit is embedded into the first electronic device and the second signal converting unit is embedded into the second electronic device.

In an embodiment, the detection method further comprises a step of receiving a confirming pattern inputted through an input interface of the first electronic device.

In an embodiment, the detection method further comprises the first electronic device is a good product when the confirming pattern is the same with the verification pattern.

In an embodiment, the detection method further comprises the first electronic device is a defective product when the confirming pattern is different from the verification pattern.

Accordingly, the detection system of multimedia interface and the detection method thereof comprise: outputting a verification signal comprising a verification pattern by the first electronic device; receiving the verification signal and converting the verification signal into a verification pattern signal by a signal converting device; receiving the verification pattern signal by a second electronic device and transmitting the verification pattern signal in a multimedia interface format from a multimedia interface output terminal of the second electronic device to the multimedia interface input terminal of the first electronic device; and displaying a verification pattern by a display screen of the first electronic device. Therefore, the normality of the input and the display of the multimedia interface of the first electronic device is determined after the detecting person inputs the confirming pattern according to the verification pattern displayed by the first electronic device and compares with the verification pattern.

### BRIEF DESCRIPTION OF THE DRAWINGS

FIG. 1A is a functional block diagram showing a detection system of multimedia interface according to a preferred embodiment of the present invention;

FIG. 1B is schematic drawing showing a display screen of a first electronic device according to an embodiment of the present invention;

FIG. 2 is a flow chart showing a detection method of multimedia interface according to a preferred embodiment of the present invention; and

FIG. 3 is another flow chart of the detection method.

### DETAILED DESCRIPTION OF THE INVENTION

The following drawings disclose a detection system of multimedia interface and a detection method thereof according to a preferred embodiment of the present invention, in which the same elements will be described with the same reference numerals.

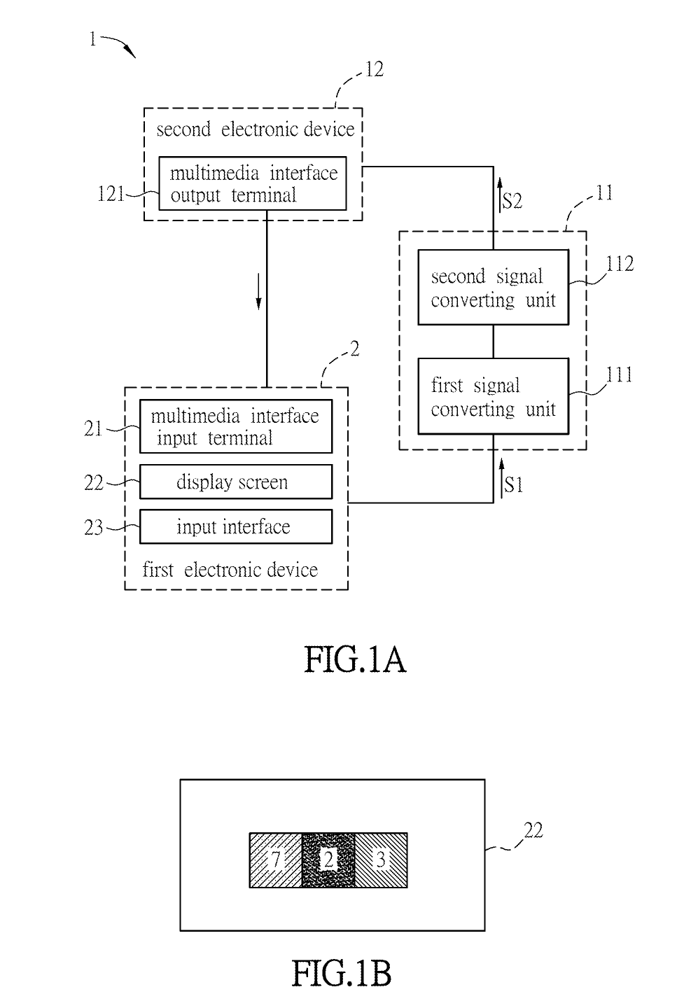

Please refer to FIG. 1A and FIG. 1B, in which FIG. 1A is a functional block diagram showing a detection system of multimedia interface 1 according to a preferred embodiment of the present invention and FIG. 1B is schematic drawing showing a display screen 22 of a first electronic device 2 according to an embodiment of the present invention.

A detection system of multimedia interface 1 (“detection system 1” hereafter) and a detection method of multimedia interface (“detection method” hereafter) are able to detect whether an input or a display of a multimedia interface of a first electronic device 2 (or an under-testing device) is normal or not, in which the first electronic device 2 is, but not limited to, a notebook (or an ultra light thin notebook), a tablet or other electronic devices capable of playing multimedia video/audio and has a controlling unit (not shown in the figure) for executing, for example, applications. The controlling unit can comprise a core controlling assembly of the first electronic device 2′ such as a central processing unit (CPU) and a memory, or other controlling hardware, software or firmware. However, the present invention is not limited thereto.

The first electronic device 2 has a multimedia interface input terminal 21, a display screen 22 and an input interface 23. A high definition multimedia interface input terminal is taken as an example for the multimedia interface input terminal 21 of the present embodiment. Thus, the detection system 2 and the detection method are particularly provided for detecting whether the input and display of the HDMI of the first electronic device 2 is normal or not. The display screen 22 is able to display the image, and the detecting person is able to input information to the first electronic device 2 through the input interface 23. In addition, the input interface 23 is, but not limited to, a keyboard (physical keys) or virtual keys (for example, touch keys). The first electronic device 2 of the present embodiment takes an all-in-one PC as an example.

As shown in FIG. 1A, the detection system 1 is applied for detecting the first electronic device 2 and comprises a signal converting device 11 and a second electronic device 12 in which the first electronic device 2 under test is able to output a verification signal S1 comprising a verification pattern. In this case, a detection program (it can be a portion of the detection system 1) can be executed on the first electronic device 2 to allow the first electronic device 2 to output the verification signal Si having the verification pattern. Preferably, the verification pattern comprises Arabic numerals, letters, phonetic symbols, colors or combination thereof The verification pattern of the present invention can be a combination of several Arabic numerals, such as three Arabic numerals, and colors. Furthermore, different numerals are corresponding to different colors (the colors are not shown in the figure). When the numerals are “723”, RGB colors can also be displayed corresponding to the numerals. For example, the numeral “7” represent red, the numeral “2” represent green and the numeral “3” represent blue (however, each color can represent different combination of RGB colors). Thus, the detecting person can check which the numeral is displayed specifically. Besides the verification pattern comprises a combination of three Arabic numerals and corresponding colors, the Arabic numerals are preferably different from each other.

The second electronic device 12 has a multimedia interface output terminal 121, and the second electronic device can be connected with the multimedia interface input terminal 21 of the first electronic device 2 through the multimedia interface output terminal 121 (using a multimedia interface connecting line). The signal converting device 11 is electrically connected between the first electronic device 2 and the second electronic device 12 and signal connected with the first electronic device 2 and the second electronic device 12, respectively. In the present embodiment, the multimedia interface input terminal 21 of the first electronic device 2 is a high-definition multimedia interface input terminal (HDMI-in) so that the multimedia interface output terminal 121 of the second electronic device 12 is a high-definition multimedia interface output terminal (HDMI-out) and connected with each other by using a HDMI connecting line. In addition, the second electronic device 12 of the present embodiment is, but not limited to, a personal computer or a server and at least has the multimedia interface output terminal 121 (that is, the high-definition multimedia interface output terminal).

The signal converting device 11 receives a verification signal S1 transmitted from the first electronic device 2 and converts the verification signal Si into a verification pattern signal S2 for outputting to the second electronic device 12. In the present embodiment, the signal converting device 11 has a first signal converting unit 111 and a second signal converting unit 112 electrically connected with the first signal converting unit 111 in which the first signal converting unit 111 is electrically connected with the first electronic device 2 and the second signal converting unit 112 is electrically connected with the second electronic device 12. In this case, the first signal converting unit 111 and the second signal converting unit 112 are connected (through an USB connecting line), respectively, with the first electronic device 2 and the second electronic device 12 by using an universal serial bus (USB) connecting port (or other connecting ports, for example, micro USB or RS-232 and so on). However, the present invention is not limited thereto. In addition, the signal converting device 11 of the present embodiment is an external equipment. However, the first signal converting unit 111 and the second signal converting unit 112 can be signal conversion cards, respectively, in different embodiments. Furthermore, the first signal converting unit 111 can be embedded into a slot in the first electronic device 2 and the second signal converting unit 112 can be embedded into a slot in the second electronic device 12. However, the present invention is not limited thereto.

In addition, the electrical connection between the first signal converting unit 111 and the second signal converting unit 112 of the present embodiment is to electrically connect the first signal converting unit 111 with the second signal converting unit 112 through a plurality of pins, for example, connecting pins (not shown in the figure). For example, 1024 combinations of different numerals can be achieved at the most if the amount of the pins is 10 (binary representation, “0” represents that the pin level is low level, “1” represents that the pin level is high level, the numerals are varied from 0 to 1023). Therefore, the first signal converting unit 111 converts the verification signal S1 into a digital signal (a combination of 0 and 1) and then the second signal converting unit 112 converts the digital signal into the verification pattern signal S2 so as to be inputted to the second electronic device 12.

The second electronic device 12 receives the verification pattern signal S2 from the first signal converting device 11 and transmits the verification pattern signal S2 to the first electronic device 2 through the multimedia interface output terminal 121 and the multimedia interface input terminal 21 in a multimedia interface format (HDMI format). And then, the verification pattern “723” will be displayed on the display screen 22 of the first electronic device 2 as show in FIG. 1B.

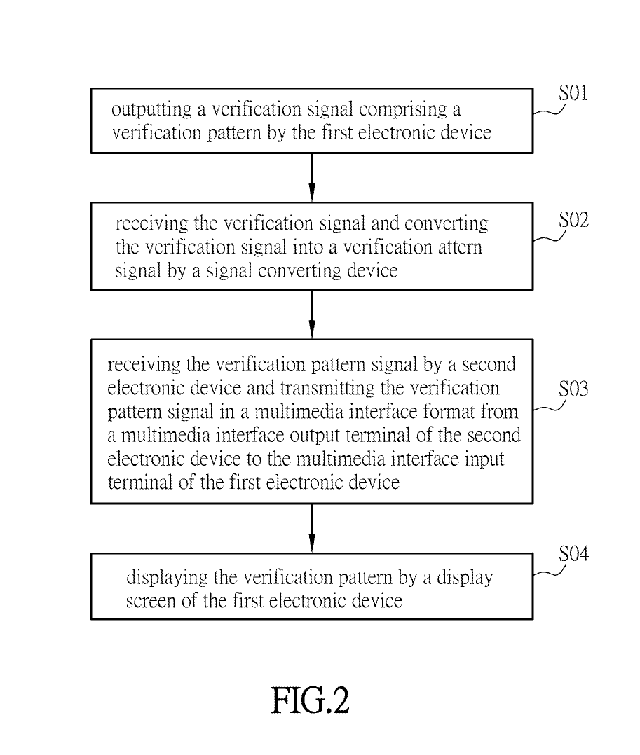

Please refer from FIG. 1A to FIG. 2 simultaneously for illustrating the detection method of multimedia interface of the present invention. FIG. 2 is a flow chart showing a detection method of multimedia interface according to a preferred embodiment of the present invention, and the detection method comprises steps S01˜S04.

First, step S01 is a step of outputting the verification signal S1 that comprises the verification pattern by the first electronic device 2.

Step S02 is then performed to receive the verification signal S1 and convert the verification signal S1 into the verification pattern signal S2 by the signal converting device 11. In this case, a detection program is executed on the first electronic device 2 to allow the first electronic device to output the verification signal S1 in which the verification signal S1 comprises the verification pattern, is received by the signal converting device 11 and is converted into the verification pattern signal S2. As shown in FIG. 1B, the verification pattern of the present embodiment is the Arabic numerals “723” with colors (the colors are not shown in the figure).

A step S03 of receiving the verification pattern signal S2 by the second electronic device 12 and transmitting the verification pattern signal S2 in a multimedia interface format from the multimedia interface output terminal 121 of the second electronic device 12 to the multimedia interface input terminal 21 of the first electronic device 2 is then performed. The present embodiment transmits the verification pattern signal S2 comprising the numerals “723” from the second electronic device 12 to the first electronic device 2 in the HDMI format.

A step S04 is then performed for displaying the verification pattern by the display screen 22 of the first electronic device 2. Therefore, different Arabic numerals “723” are displayed as shown in FIG. 1B. The second electronic device 12 certainly can be provided with a display screen for displaying the same verification pattern at the same time.

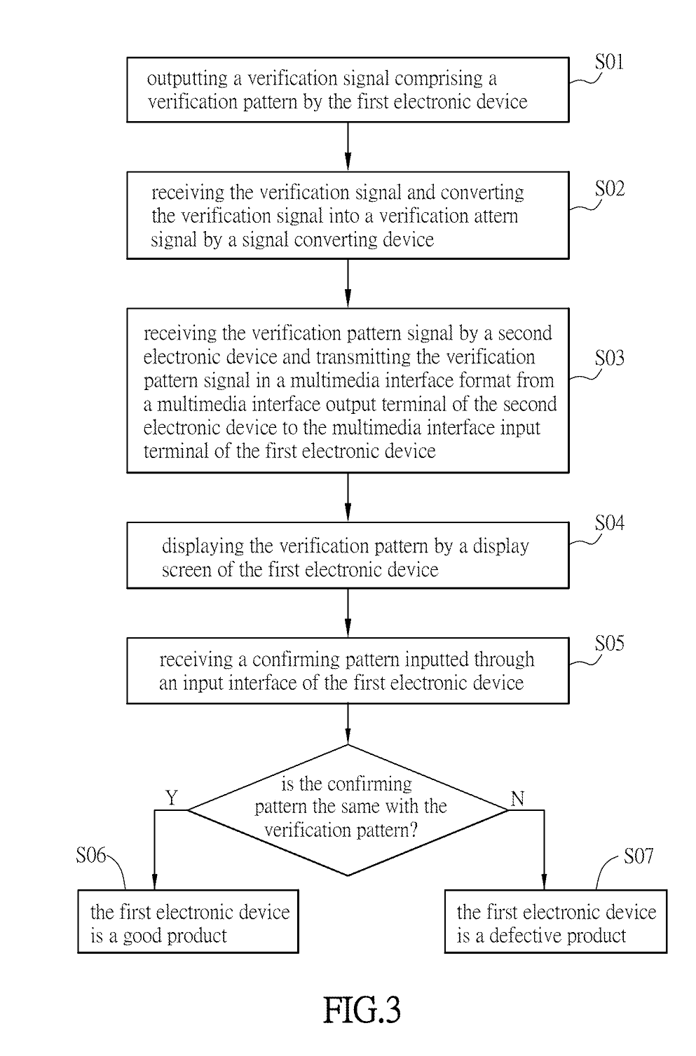

Please further refer to FIG. 3 that is another flow chart of the detection method. Aside from the steps S01˜S04, the detection further comprises steps S05˜S07.

After display the verification pattern on the display screen 22 of the first electronic device 2, a step S05 is performed for receiving a confirming pattern inputted through an input interface 23 of the first electronic device 2. In this case, on the display screen 22 of the first electronic device 2, the detection program can request a detecting person to input the confirming pattern through the input interface 23 according to the seen verification pattern, that is, 723, in which the detecting person can input the Arabic numerals “723” displayed by the display screen 22 in order through a keyboard. In practical, the display screen 22 can not only display a plurality of letters (the verification pattern) but also can display for example a sentence “ please input the numerals corresponding to the displayed numerals”. Thus, the detecting person can input the confirming pattern according to the request.

The detection program is able to perform the determination after receiving the inputted confirming pattern. The first electronic device is determined to be a good product when the confirming pattern inputted by the detecting person is the same as the verification pattern (both are numerals“723”) as shown in step S06. The first electronic device is a defective product when the confirming pattern is confirmed to be different from the verification pattern as shown in step S07. When the confirming pattern inputted by the detecting person is the same with the verification pattern sent from the first electronic device 2, it means that the verification pattern seen by the detecting person on the display screen 22 is the same with the original one outputted from the first electronic device 2 after the verification signal S1 comprising the verification pattern is outputted by the first electronic device 2, converted, sent back to the first electronic device 2 in the multimedia interface (for example, HDMI of the present embodiment) through the second electronic device 12 and then displayed. Therefore, the input and display of the multimedia interface of the first electronic device 2 is normal. In addition, when the confirming pattern inputted by the detecting person is different from the verification pattern sent from the first electronic device 2, it means that the verification pattern seen by the detecting person on the display screen 22 is different from the original one outputted from the first electronic device 2 (unexpected changes are occurred) after the verification signal S1 comprising the verification pattern is outputted by the first electronic device 2, converted, sent back to the first electronic device 2 in the multimedia interface through the second electronic device 12 and then displayed. Therefore, the input and display of the multimedia interface of the first electronic device 2 is abnormal. Therefore, the normality of the input and the display of the multimedia interface of the first electronic device is determined after the detecting person inputs the confirming pattern according to the verification pattern displayed by the first electronic device and compares with the verification pattern. Thus, the present invention is able to improve quality control problems of the first electronic device resulted from the laziness or incautiousness of the conventional detecting person.

In addition, other features of the detection method also can refer to the description of the above detection system 1.

To sum up, the detection system of multimedia interface and the detection method thereof comprise: outputting a verification signal comprising a verification pattern by the first electronic device; receiving the verification signal and converting into a verification pattern signal by a signal converting device; receiving the verification pattern signal by a second electronic device and transmitting the verification pattern signal in a multimedia interface format from a multimedia interface output terminal of the second electronic device to the multimedia interface input terminal of the first electronic device; and displaying the verification pattern by a display screen of the first electronic device. Therefore, the normality of the input and the display of the multimedia interface of the first electronic device is determined after the detecting person inputs the confirming pattern according to the verification pattern displayed by the first electronic device and compares with the verification pattern. Thus, the present invention is able to improve quality control problems of the first electronic device resulted from the laziness or incautiousness of the conventional detecting person.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A detection system of multimedia interface for detecting a first electronic device, wherein the first electronic device has a display screen and a multimedia interface input terminal, comprising:
a signal converting device receiving a verification signal that comprises a verification pattern and is outputted by the first electronic device under test and converting the verification signal into a verification pattern signal; and
a second electronic device having a multimedia interface output terminal, wherein the second electronic device is able to be connected with the multimedia interface input terminal of the first electronic device through the multimedia interface output terminal, the signal converting device is signal connected with the first electronic device and the second electronic device, respectively, and the second electronic device receives the verification pattern signal from the signal converting device and transmits the verification pattern signal in a multimedia interface format to the multimedia interface input terminal of the first electronic device through the multimedia interface output terminal so as to display the verification pattern by the display screen.

2. The detection system according to claim 1, wherein the verification pattern comprises Arabic numerals, letters, phonetic symbols, colors or combination thereof.

3. The detection system according to claim 1, wherein the verification comprises a combination of a plurality of Arabic numerals and the Arabic numerals are different from each other.

4. The detection system according to claim 1, wherein the signal converting device has a first signal converting unit and a second signal converting unit electrically connected with the first signal converting unit in which the first signal converting unit is electrically connected with the first electronic device and the second signal converting unit is electrically connected with the second electronic device.

5. The detection system according to claim 4, wherein the first signal converting unit converts the verification signal into a digital signal and the second signal converting unit coverts the digital signal into the verification pattern signal.

6. The detection system according to claim 4, wherein the first signal converting unit is embedded into the first electronic device and the second signal converting unit is embedded into the second electronic device.

7. A detection method of multimedia interface for detecting a first electronic device, comprising:
outputting a verification signal comprising a verification pattern by the first electronic device;
receiving the verification signal and converting the verification signal into a verification pattern signal by a signal converting device;
receiving the verification pattern signal by a second electronic device and transmitting the verification pattern signal in a multimedia interface format from a multimedia interface output terminal of the second electronic device to the multimedia interface input terminal of the first electronic device; and
displaying the verification pattern by a display screen of the first electronic device.

8. The detection method according to claim 7, further comprising:
receiving a confirming pattern inputted through an input interface of the first electronic device.

9. The detection method according to claim 8, further comprising:
the first electronic device is a good product when the confirming pattern is the same with the verification pattern.

10. The detection method according to claim 8, further comprising:
the first electronic device is a defective product when the confirming pattern is different from the verification pattern.
